(19) United States
(12) Patent Application Publication
(10) Pub. No.: US 2002/0056740 A1
(43) Pub. Date: May 16, 2002

(54) Flip chip bonding method

(75) Inventor: Eiji Hayashi, Tokyo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 09/810,454

(22) Filed: Mar. 19, 2001

(30) Foreign Application Priority Data
Nov. 16, 2000 (JP) 2000-349489

(51) Int. Cl. B23K 1/06; B23K 5/20; B23K 35/38

(52) U.S. Cl. 228/110.1; 228/180.22; 228/219; 228/220

(57) ABSTRACT

A flip chip bonding method including steps of applying a pressure and a heat and applying an ultrasonic wave in a plurality of directions or along a circular locus for connecting solder bumps, which are formed on one or both of a connecting pad of a semiconductor element or a connecting pad of a wiring board, whereby flip chip bonding is performed without using flux, a drop of yield and deterioration of reliability are improved.

### BACKGROUND OF THE INVENTION

### Field of the Invention

The present invention relates to a flip chip bonding method, by which electrodes of a semiconductor element is connected to a mount pad of a wiring board in use of an ultrasonic flip chip bonding.

### Discussion of Background

As one of technologies of assembling a semiconductor element, a flip chip bonding method is known. This bonding method is to connect solder bumps on electrodes, located on lower surfaces of the semiconductor element to solder bumps on a connecting pad, located on an upper surface of a wiring board.

However, the conventional flip chip bonding method uses flux. Flux removes oxide films on surfaces of solder bumps and to facilitate connections by solder. However, if the quantity of the flux is not optimized or a step of cleaning is not controlled, there are problems that the flux is left as propellant fouling after the step of cleaning, and the propellant fouling prevents a sealing resin from being injected in a later step, whereby voids are induced, an yield is dropped, and reliability is spoiled.

### SUMMARY OF THE INVENTION

It is an object of the present invention to solve the above-mentioned problems inherent in the conventional technique and to provide a flip chip bonding method for connecting a semiconductor element with a wiring board by connecting electrodes of the semiconductor element with a connecting pad of the wiring board in use of flip chip bonding without using flux.

According to a first aspect of the present invention, there is provided a flip chip bonding method in mounting a semiconductor element on a wiring board comprising steps of:

applying a pressure and a heat to solder bumps, formed on both or one of a connecting pad of the semiconductor element or a connecting pad of the wiring board for connecting the solder bumps under a state that the solder bumps are in contact and fused while an ultrasonic bonding head is moved in a plurality of directions or along a circular locus.

According to a second aspect of the present invention, there is provided the flip chip bonding method,

wherein the steps of connecting the solder bumps is performed by a device, in which an inactive atmosphere or a reducing atmosphere is formed.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1a schematically illustrates a step of mounting a semiconductor element according to Embodiment 1 of the present invention;

FIG. 1b schematically illustrates the step of mounting the semiconductor element according to Embodiment 1 of the present invention;

FIG. 1c schematically illustrates the step of mounting the semiconductor element according to Embodiment 1 of the present invention;

FIG. 1d schematically illustrates the step of mounting the semiconductor element according to Embodiment 1 of the present invention;

FIG. 1e schematically illustrates the step of mounting the semiconductor element according to Embodiment 1 of the present invention; and

FIG. 2 is a cross-sectional view illustrating a state that an air shielding box is mounted on a wiring board according to Embodiment 2 of the present invention.

### DETAILED DESCRIPTION OF THE PREFERRED EMBODIMENTS

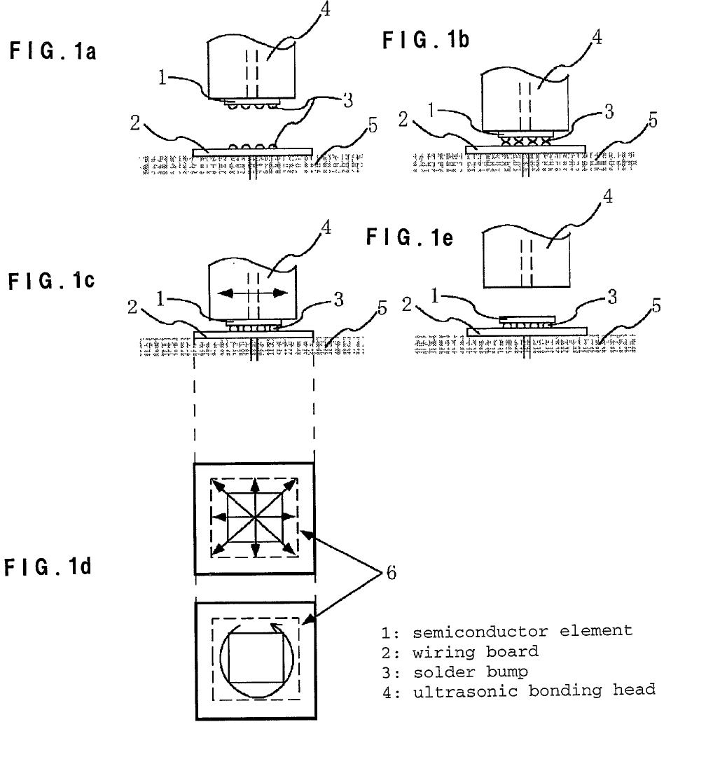

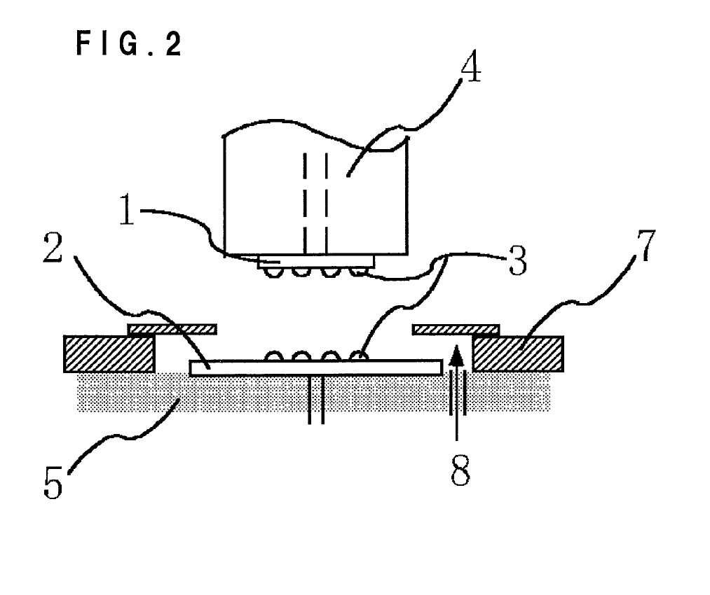

A detailed explanation will be given of preferred embodiments of the present invention in reference to FIGS. 1a through 2 as follows, wherein the same numerical references are used for the same or similar portion and description of these portions is omitted.

Embodiment 1

A flip chip bonding method according to the present invention is characterized by that, at a time of connecting solder bumps, formed on one or both of a connecting pad of a semiconductor element or a connecting pad of a wiring board, a step of applying an ultrasonic wave in a plurality of directions or along a circular locus under a state that a pressure is applied, a heat is applied, and the solder bumps are in contact and fused is processed.

FIGS. 1a through 1e illustrate the step of mounting the semiconductor element according to Embodiment 1, wherein the figures are viewed from a cross section or from an upper side.

At first, a bonding device will be described.

The solder bumps 3 are located on the connecting pad of the semiconductor element 1 and the connecting pad of the wiring board 2. Flux is not supplied to the solder bumps 3, located on the semiconductor element 1 and the wiring board 2, according to Embodiment 1. An ultrasonic bonding head 4 sucks the semiconductor element 1 by vacuum and can apply an ultrasonic wave while heating the semiconductor element 1 from a room temperature to 400° C. In a bonding stage 5, a heater is build-in to previously heat the wiring board 2 to a temperature around a fusing point of solder.

Mounting will be described.

As illustrated in FIG. 1a, the wiring board 2 is registered and mounted on an upper surface of the bonding stage 5, heated around the fusing point of solder. On the other hand, the semiconductor element 1 is sucked on a lower surface of the ultrasonic bonding head 4, heated less than the fusing point of solder. The semiconductor element 1 is positioned above the wiring board 2 so as to be aligned by a horizontal movement of the ultrasonic bonding head 4.

As illustrated in FIG. 1b, the ultrasonic bonding head 4 is downward moved, and the semiconductor element 1 is mounted at a predetermined position on the wiring board 2. Under this state, since the semiconductor element is sucked on the lower surface of the ultrasonic bonding head 4, the semiconductor element is in contact with the wiring board 2 with pressure by application of a pressure for a predetermined time in a vertical direction. Therefore, it is possible to increase contact areas of all of the solder bumps 3, and it possible to previously break parts of oxide films on the solder bumps 3.

As illustrated in FIG. 1c, under the state that the solder bumps of the semiconductor element 1 and the wiring board 2 are in contact with each other, the semiconductor element 1 and the wiring board 2 are heated at a temperature of the fusing point of solder or more. Further, as illustrated in numerical reference 6 of FIG. 1d, an ultrasonic wave is applied in a plurality of directions or along a circular locus within an area of one of the bumps, wherein in FIG. 1d, a moving range of the ultrasonic bonding head is illustrated in an exaggerated form. Then the oxide films covering surfaces of the solder bumps 3 are taken inside the solder bumps 3, whereby it becomes possible to bond without using flux.

Succeedingly, as illustrated in FIG. 1e, by cooling the ultrasonic bonding head 4 to be a temperature of the fusing point of solder or less, a temperature of the semiconductor element 1 is decreased, and the solder bumps 3 are solidificated by the temperature decrement. Thereafter, the suction of the semiconductor element 1 is released and the ultrasonic bonding head 4 is raised, wherein the flip chip bonding is completed.

Embodiment 2

FIG. 2 is a cross-sectional view of a state that an air shielding box 7 is located on a wiring board 2 according to Embodiment 2 of the present invention. In other words, the air shielding box 7 is provided in the bonding device according to Embodiment 1. A gas thermophone and a supply source of an inert gas or a reducing gas 8 are connected to the air shielding box 7 to constantly fill a mixed gas of the inert gas or the reducing gas 8, heated at around a fusing point of solder in the air shielding box. Therefore, it is possible to prevent surfaces of solder bumps, located on a semiconductor element 1 and a wiring board 2, from being oxidized and/or to reduce oxide films, whereby junctions are further stabilized. Further, the above-mentioned method is not limited by materials of the solder bumps 3.

The first advantage of the flip chip bonding method according to the present invention is that flip chip bonding is performed without using flux.

The second advantage of the flip chip bonding method according to the present invention is that junctions are further stabilized.

Obviously, numerous modifications and variations of the present invention are possible in light of the above teachings. It is therefore to be understood that within the scope of the appended claims, the invention may be practiced otherwise than as specifically described herein.

The entire disclosure of Japanese Patent Application No. 2000-349489 filed on Nov. 16, 2000 including specification, claims, drawings and summary are incorporated herein by reference in its entirety.

What is claimed is:

1. A flip chip bonding method for mounting a semiconductor element on a wiring board comprising steps of:
applying a pressure and a heat to solder bumps, formed on both or one of a connecting pad of the semiconductor element or a connecting pad of the wiring board for connecting the solder bumps under a state that the solder bumps are in contact and fused while an ultrasonic bonding head is moved in a plurality of directions or along a circular locus.

2. The flip chip bonding method according to claim 1,
wherein the steps of connecting the solder bumps is performed by a device, in which an inactive atmosphere or a reducing atmosphere is formed.
